(19) United States
(12) Patent Application Publication
(10) Pub. No.: US 2025/0182560 A1
(43) Pub. Date: Jun. 5, 2025

(54) GAMING TABLE DEVICES AND METHODS OF USING THE SAME

(71) Applicant: Tilt LLC, Terre Haute, IN (US)

(72) Inventors: Zachary Johnson, Terre Haute, IN (US); Samuel Shor, Terre Haute, IN (US); Ross McClintock, Terre Haute, IN (US)

(73) Assignee: Tilt LLC, Terre Haute, IN (US)

(21) Appl. No.: 18/965,448

(22) Filed: Dec. 2, 2024

Related U.S. Application Data
(60) Provisional application No. 63/605,092, filed on Dec. 1, 2023.

(51) Int. Cl. G07F 17/32; G06K 7/14

(52) U.S. Cl. CPC G07F 17/322; G06K 7/1417; G07F 17/3223; G07F 17/3237; G07F 17/3272; G07F 17/3293

(57) ABSTRACT

Gaming table devices and methods of using the same. A gaming device referenced herein can include a gaming table including a processor in communication with a storage medium and memory, the storage medium configured to store instructions accessible by the processor to operate the gaming table so to display a graphical user interface on a screen, the gaming table configured to wirelessly connect to two or more remote devices such that when a game is played on the gaming table, two or more users of the two or more remote devices can play the game using information displayed on the gaming table and with unique information displayed on each of the two or more remote devices.

### PRIORITY

The present application is related to, and claims the priority benefit of, U.S. Provisional Patent Application Ser. No. 63/605,092, filed Dec. 1, 2023, the contents of which are incorporated herein directly and by reference in their entirety.

### BACKGROUND

There are many electronic devices available today that allow people to play games. These include personal computers, mobile phones, tablets, video game consoles, and televisions among many others. As the industry continues to grow and technology advances, more opportunities are created for people to play games together in a social environment on new technologies and software platforms.

### BRIEF SUMMARY

The present disclosure includes disclosure of a gaming device, as shown and/or described herein.

The present disclosure includes disclosure of a method of playing a game with multiple users, as shown and/or described herein.

The present disclosure includes disclosure of a gaming device, the gaming device comprising a gaming table comprising a processor in communication with a storage medium and memory, the storage medium configured to store instructions accessible by the processor to operate the gaming table so to display a graphical user interface on a screen, the gaming table configured to wirelessly connect to two or more remote devices such that when a game is played on the gaming table, two or more users of the two or more remote devices can play the game using information displayed on the gaming table and with unique information displayed on each of the two or more remote devices.

The present disclosure includes disclosure of a gaming device, wherein the information displayed on the gaming table is displayed on a screen.

The present disclosure includes disclosure of a gaming device, wherein the two or more remote devices comprise smartphones.

The present disclosure includes disclosure of a gaming device, wherein the two or more remote devices comprise digital tablets.

The present disclosure includes disclosure of a gaming device, wherein one or more additional users can play the game directly using the gaming table.

The present disclosure includes disclosure of a gaming device, wherein the two or more users can connect their remote device to the gaming table by scanning one or more quick response (QR) codes displayed on the gaming table.

The present disclosure includes disclosure of a gaming device, wherein location information is used to confirm that that the two or more users are within a specified physical proximity of the gaming table.

The present disclosure includes disclosure of a gaming device, configured to rotate at least part of the information displayed on the gaming table depending upon which user of the two or more users is actively playing the game at a particular time.

The present disclosure includes disclosure of a gaming device, configured such that if a user of the two or more users is eliminated from the game, said user can use one of the two or more remote device to join a different game on a different gaming table.

The present disclosure includes disclosure of a gaming device, configured such that if a user of the two or more users is eliminated from the game, the remaining users of the two or more users can be reorganized to play in a different order.

The present disclosure includes disclosure of a gaming device, configured such that a user of the two or more users can use a remote device of the two or more remote devices to order food and/or beverage to be delivered to said user.

The present disclosure includes disclosure of a gaming device, wherein the game is a digital playing card game, and wherein the two or more remote devices are used to display digital playing cards related to each user of the two or more users.

The present disclosure includes disclosure of a gaming device, wherein digital playing chips associated with each user of the two or more users are displayed on the game table.

The present disclosure includes disclosure of a gaming device, wherein each user can transfer one or more of the digital playing cards from a remote device of the two or more remote devices to the gaming table to be displayed on the gaming table.

The present disclosure includes disclosure of a gaming device, further comprising a second gaming table, whereby game play on the gaming table and game play on the second gaming table is associated with each other such that a single game can be played using the gaming table and the second gaming table.

The present disclosure includes disclosure of a gaming device, further comprising a third gaming table, whereby the game play on the gaming table, the game play on the second gaming table, and game play on the third gaming table is associated with each other such that a single game can be played using the gaming table, the second gaming table, and the third gaming table.

The present disclosure includes disclosure of a gaming device, wherein when one or more users of the gaming table and wherein one or more users of the second gaming table are eliminated from the single game, remaining users of the second gaming table are reorganized to be associated with remaining users of the first gaming table.

The present disclosure includes disclosure of a method of digital game play, comprising operating an exemplary gaming device of the present disclosure to play a game.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a block component diagram of components of a gaming device configured as a gaming table, according to an exemplary embodiment of the present disclosure;

FIG. 2 shows a diagram of four users, each user using a remote electronic device, positioned around a gaming device, according to an exemplary embodiment of the present disclosure;

FIG. 3 shows an image of an exemplary gaming device configured as a gaming table, according to an exemplary embodiment of the present disclosure;

FIG. 4 shows a block diagram of twelve users playing a game around three tables, so four users per table, according to an exemplary embodiment of the present disclosure; and

FIG. 5 shows a block diagram of the final four users playing a game around a single table, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

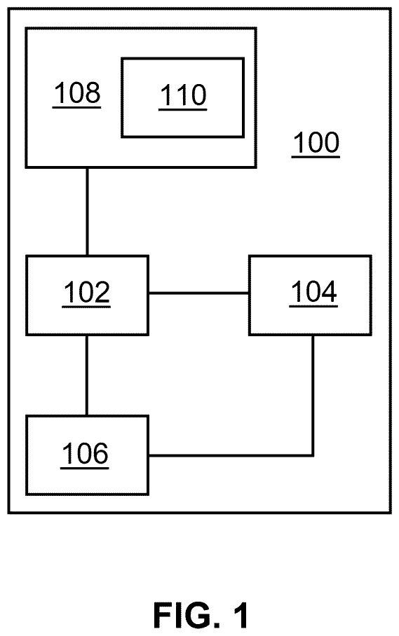

An exemplary device of the present disclosure is shown in FIG. 1. As shown therein, gaming device 100 comprises a digital gaming table, namely an electronic device with a screen configured to facilitate digital game play, such as video games, digital card games, digital board games, and the like. Gaming devices 100 of the present disclosure are configured to interact with remote electronic devices 200, which include, but are not limited to, smartphones and digital tablets.

As shown in FIG. 1, an exemplary gaming device 100 comprises a microprocessor 102, system memory 104, a storage device 106 (such as a hard drive, SSD drive, a USB drive, and the like) configured to store software/instructions thereon, accessible by microprocessor 102 using system memory 104 to execute said software/instructions. Microprocessor 102 is further operable to obtain additional software/instructions from a local network and/or an internet (external network), as may be desired. A screen 108 in communication with processor 102 is configured to display a graphical user interface (GUI) 110, such as one or more video games, digital card games, digital board games, and the like, thereon to facilitate game play. In at least one embodiment, gaming device 100 is operable using Takoha software developed by Diverted River Technology. Takoha, in combination with a digital table and mobile app technology, will enable multiple users 202 (as discussed in further detail herein) who are in close proximity to play games together in several unique ways.

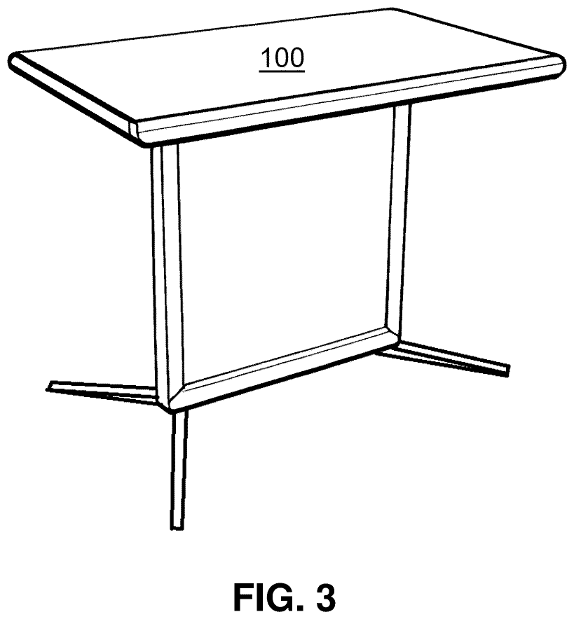

Gaming tables (gaming device 100) can have an appearance and/or features such as the digital image of an exemplary gaming device 100 shown in FIG. 3

For any game that is being played, all players will be able to see the public game assets displayed on gaming device 100 (the community information on the digital table), as well as additional personal game assets (private information) via their mobile phone (an exemplary remote electronic device 200). Users can interact with any game using either the table (gaming device 100), their mobile device (an exemplary remote electronic device 200), or a combination of the two. Each gaming device 100 acts like a host, in order to connect clients (the mobile phones from each player) to a game.

In at least one embodiment, each user can initially scan a digitally displayed quick response (QR) code on the table (gaming device 100) in order to create a connection with Takoha (and/or other software used in connection with gaming device 100) to become a “player” in a game which is hosted by Takoha software (and/or other software used in connection with gaming device 100) running on each table. The player, along with several others who may have also connected their mobile device (an exemplary remote electronic device 200) with the table (gaming device 100), will then be able to play together in a social multiplayer game. Each game will be played using a combination of public information (displayed on the table) combined with each players' private information (which only they can see, on their mobile phone, for example).

The tables (gaming devices 100) in any venue can control the flow, rules and logistics of commonly played games; replacing a human “dealer,” “game master,” or “event organizer.” Across any number of physical venues (such as a stand-alone restaurant, a restaurant chain, a bar, etc.), multiple tables (gaming devices 100) can be connected across the internet as part of a local or wide area network to facilitate large scale competitions or tournaments. In at least one embodiment, gaming devices 100 can be configured to verify and confirm the physical presence of the player (user 202) to the table (gaming device 100) and/or a room of tables (gaming devices 100) using the tables as the hosts. For example, and in at least one embodiment, a combination of verified local IP addresses and MAC addresses on the same local area network (LAN), Bluetooth technology (which has a limitation of approximately 30 foot communication distance), and location verification that players will allow from their mobile devices while using the Takoha app will allow the tables (gaming devices 100) to function as a group with known users 202.

Takoha software (for example) can understand who is connected to each table and from which “seat” they are playing. This will allow the software to rotate or split the table display depending on the player whose turn it is to act. Additionally, if a player is eliminated from a game for any reason, another player will have the ability to join an ongoing game. It will also be possible for the system to reorganize the seating positions of all players in a multi-table event (such as instructing players to move to a specified seat). For example, and in a tournament game, a player may be eliminated, while another player is qualified, and seating adjustments will need to be made.

In addition to playing multiplayer games in real time, users can also interact with either the table (gaming device 100) or mobile device (an exemplary remote electronic device 200) in order to purchase food and/or beverages, which can then be delivered to their known physical location, while the game is being played.

By way of example, an exemplary gaming device 100 of the present disclosure may be used to play video/digital poker. Assuming two or more players (users 202), such as two, three, four, or more, are playing said poker game, an issue that would hinder effective game play would be that the players (users 202) would not be able to “hide” their cards, or keep them secret, if they were displayed on said display screen 108. As such, an exemplary gaming device 100 is configured to communicate with one or more remote electronic devices 200 to facilitate individual game play.

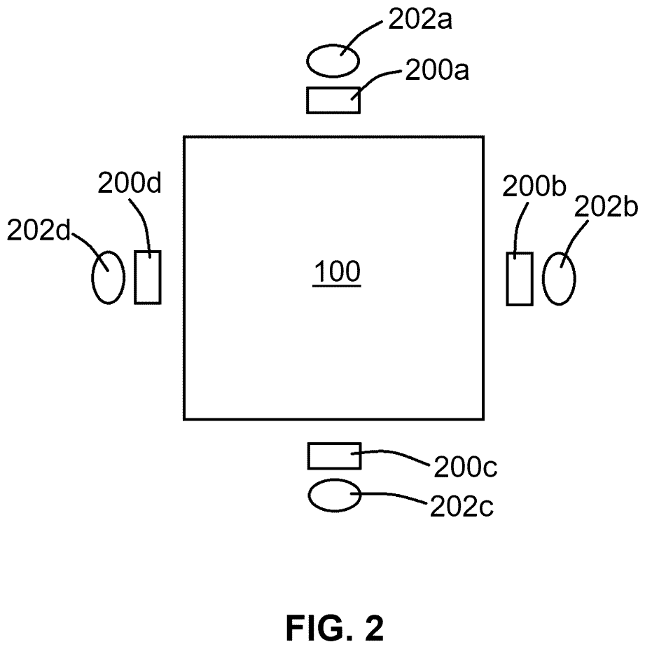

In this example, we have four players (users 202), namely Andy, Betty, Carl, and Debbie. Andy (exemplary user 202a), Betty (exemplary user 202b), Carl (exemplary user 202c), and Debbie (exemplary user 202d), as shown in FIG. 2, use their own (or borrowed) electronic devices 200, such as, for example, smartphones (electronic devices 200) 200a and 200b (for users 202a and 202b, respectively), and digital tablets (electronic devices 200) 200c and 200d (for users 202c and 202d, respectively). Each user 202 would sync their electronic device 200 with the game table (gaming device 100) so that, as in this example, devices 200a, 200b, 200c, and 200d would each individually communicate with the game table (gaming device 100).

So, for example, a poker game could start, and each player (user 202) would be dealt their two cards. Andy (user 202a) would “receive” his two cards digitally on his smartphone (electronic device 200a), as would Betty (user 202b using electronic device 200b), Carl (user 202c using electronic device 200c), and Debbie (user 202d using electronic device 200d). Display screen 108 would be the main screen used by all users 202, and, for example, each player's “stack of chips” could be visually depicted on said display screen 108, as the number and amount of chips each player has is not secret to each individual player. However, no user could see the cards being held by another user, as the cards would be private to that user.

Andy (user 202a), for example, can use his electronic device 200a to “play” his hand, such as by betting, folding, etc. Betty (user 202b) can then play her hand, as then can Carl (user 202c) and Debbie (user 202d). The game play would then continue centrally, by, for example, revealing the first three communal cards (the “flop”), and then game play continues with the individual users.

Gaming tables (gaming devices 100) of the present disclosure are capable of allowing users 202 to virtually play with virtual gaming pieces between the various electronic devices 200 and the gaming device 100. Playing Euchre, for example, would have the overall “feel” that the users 202 are playing a physical card game while moving cards from their “hand” (their mobile device or tablet 200) to the “table” (the screen of the central gaming device 100 in front of them).

Aside from effectively converting physical games into virtual games, the present disclosure also includes disclosure of developing new games and new ways to play that might not be available in either an all virtual or an all-physical world. This is not meant to be online or played remotely, as the games of the present disclosure are about humans physically sitting around a real table (gaming device 100) and how those screens (gaming device 100 and electronic devices 200) interact with each other.

The present disclosure also includes disclosure of the ability to connect multiple tables (gaming devices 100) in the same venue or location together to seamlessly run events and move players (users 202) around in leagues and tournaments. So, in the event games like Euchre (or Bridge, or Hearts, or even Catan or other traditional board games if desired) we can have any number of players (users 202, such as three, four, five, six, eight, ten, twelve, twenty, thirty, forty, or more or fewer users 200, in teams of two, three, four, or more) show up at a particular venue for a league night. They can be directed to their first match via the phone (electronic device 200), scan a QR code (for example) on their table (gaming device 100) with their partner scanning and standing across from them, and the overall system can guarantee that the appropriate teams are sitting at the correct table.

Scoring can be in real time across all of those tables (gaming devices 100), and dynamic brackets and seating in the venue can be done in real time as well. So as a team advances, the system can re-seat the winners bracket matches towards the front/stage of the venue and the losers could be placed in the back or side of the venue, for example. The control of the player (user) being identified by their mobile device (electronic device 200) and attached for matches to the physical tables (devices) has never been done before and is from to the present disclosure. The general concept of moving digital “pieces” for a game among the gaming device 100 and electronic devices 200) is also novel to the present disclosure.

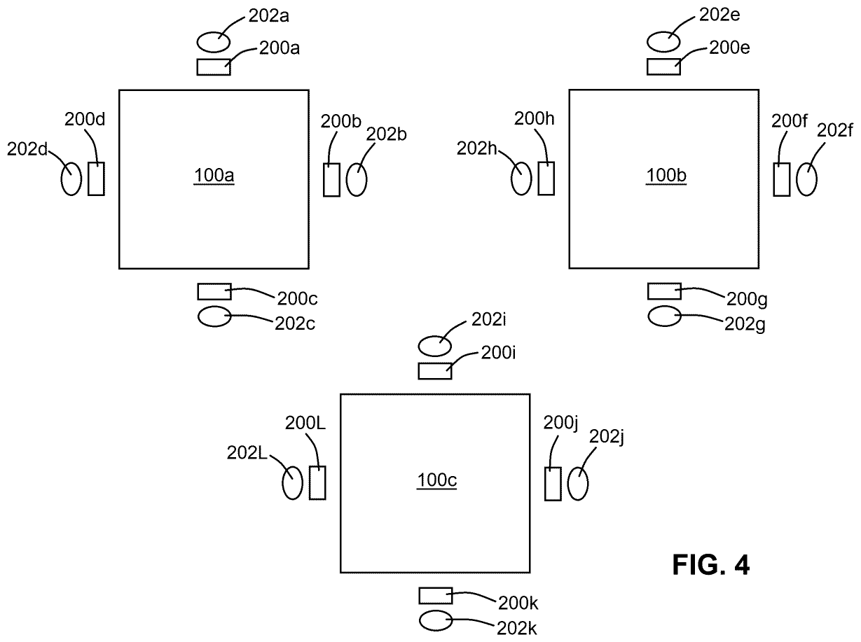

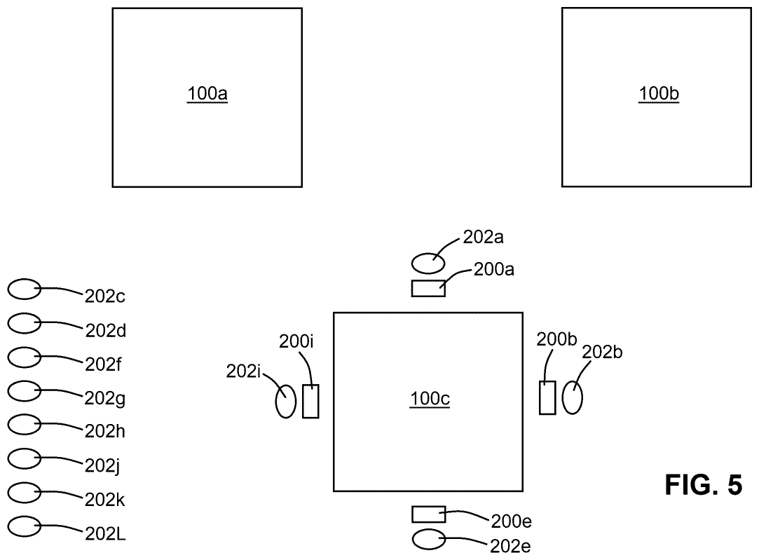

In at least one embodiment, and as shown in FIG. 4, there is an effective group or tournament game, with four users 200 per table (gaming device 100). Users 202a, 202b, 202c, and 202d (using electronic devices 200a, 200b, 200c, and 200d, respectively) are at gaming device 100a, users 202e, 202f, 202g, and 202h (using electronic devices 200e, 200f, 200g, and 200h, respectively) are at gaming device 100b, and users 202i, 202j, 202k, and 202L (using electronic devices 200i, 200j, 200k, and 200L, respectively) are at gaming device 100c. During this group or tournament game, the goal is to determine a single winner, but in other game versions, the goal is to determine a winning team, winning table or group, etc. Regardless of game played, and in this hypothetical, users 202c, 202d, 202f, 202g, 202h, 202j, 202k, and 202L are defeated (or otherwise removed from the active game), meaning that users 202a, 202b, 202e, and 202i remain. In such an embodiment, the users continuing the game (202a, 202b, 202e, and 202i) can be reseated at one game table (gaming device 100c, for example), so that play continues at that table until a winner is determined, such as shown in FIG. 5. Users 202c, 202d, 202f, 202g, 202h, 202j, 202k, and 202L can be reseated at gaming devices 100a and 100b, for example, or they can just become spectators, for example, and as shown in FIG. 5.

There are many games which can be integrated into a game table (gaming device 100). Each game would require a custom version to be created so as to be compatible with the system. They include, but are not limited to:
Card games (such as Euchre, Bridge, Poker, etc.);
Board games (such as Monopoly, Clue, Chess, etc.);
Quiz games (such as Pubquiz);
Other games (such as Bingo); and
Role Playing Games (such as Dungeons & Dragons, etc.).

While various embodiments of gaming table devices and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A gaming device, comprising:
a gaming table comprising a processor in communication with a storage medium and memory, the storage medium configured to store instructions accessible by the processor to operate the gaming table so to display a graphical user interface on a screen;
the gaming table configured to wirelessly connect to two or more remote devices such that when a game is played on the gaming table, two or more users of the two or more remote devices can play the game using information displayed on the gaming table and with unique information displayed on each of the two or more remote devices.

2. The gaming device of claim 1, wherein the information displayed on the gaming table is displayed on a screen.

3. The gaming device of claim 1, wherein the two or more remote devices comprise smartphones.

4. The gaming device of claim 1, wherein the two or more remote devices comprise digital tablets.

5. The gaming device of claim 1, wherein one or more additional users can play the game directly using the gaming table.

6. The gaming device of claim 1, wherein the two or more users can connect their remote device to the gaming table by scanning one or more quick response (QR) codes displayed on the gaming table.

7. The gaming device of claim 1, wherein location information is used to confirm that that the two or more users are within a specified physical proximity of the gaming table.

8. The gaming device of claim 1, configured to rotate at least part of the information displayed on the gaming table depending upon which user of the two or more users is actively playing the game at a particular time.

9. The gaming device of claim 1, configured such that if a user of the two or more users is eliminated from the game, said user can use one of the two or more remote device to join a different game on a different gaming table.

10. The gaming device of claim 1, configured such that if a user of the two or more users is eliminated from the game, the remaining users of the two or more users can be reorganized to play in a different order.

11. The gaming device of claim 1, configured such that a user of the two or more users can use a remote device of the two or more remote devices to order food and/or beverage to be delivered to said user.

12. The gaming device of claim 1, wherein the game is a digital playing card game, and wherein the two or more remote devices are used to display digital playing cards related to each user of the two or more users.

13. The gaming device of claim 12, wherein digital playing chips associated with each user of the two or more users are displayed on the game table.

14. The gaming device of claim 12, wherein each user can transfer one or more of the digital playing cards from a remote device of the two or more remote devices to the gaming table to be displayed on the gaming table.

15. The gaming device of claim 1, further comprising:
a second gaming table, whereby game play on the gaming table and game play on the second gaming table is associated with each other such that a single game can be played using the gaming table and the second gaming table.

16. The gaming device of claim 15, further comprising:
a third gaming table, whereby the game play on the gaming table, the game play on the second gaming table, and game play on the third gaming table is associated with each other such that a single game can be played using the gaming table, the second gaming table, and the third gaming table.

17. The gaming device of claim 15, wherein when one or more users of the gaming table and wherein one or more users of the second gaming table are eliminated from the single game, remaining users of the second gaming table are reorganized to be associated with remaining users of the first gaming table.

18. A method of digital game play, comprising:
operating the gaming device of claim 1 to play the game.
